(19) United States
(12) Patent Application Publication
(10) Pub. No.: US 2020/0185798 A1
(43) Pub. Date: Jun. 11, 2020

(54) METHOD AND SYSTEM FOR JOINING CELLS TO A BATTERY COLDPLATE

(71) Applicant: NIO USA, Inc., San Jose, CA (US)

(72) Inventors: Adam H. Ing, San Francisco, CA (US); Rick Rajaie, Rochester Hills, MI (US)

(21) Appl. No.: 16/210,150

(22) Filed: Dec. 5, 2018

(51) Int. Cl. H01M 10/6554; H01M 2/10; H01M 10/613; H01M 10/625

(52) U.S. Cl. CPC H01M 10/6554; H01M 2/1077; H01M 2220/20; H01M 10/625; H01M 10/613

(57) ABSTRACT

An energy storage module having improved design and functionality is provided, and methods of manufacturing the same. The device can be a battery module that includes: energy storage cells, each of the energy storage cells having an upper side and a lower side, where the energy storage cells are arranged in a pattern with each energy storage cell being spaced apart from one another, and wherein the upper sides of each of the energy storage cells are adjacent to one another; a cold plate including a transparent material; and a UV-cured adhesive in contact with the cold plate and each of the energy storage cells.

### FIELD

The present disclosure is generally directed to improved methods and systems for joining electrochemical cells to a battery cold plate.

### BACKGROUND

In recent years, the demand for high performance batteries has increased, driven in part by the increasingly large number of portable consumer electronics products and growing needs of batteries for fuel efficient vehicles. Lithium-ion cells are found in many applications requiring high energy and high power densities, as they can provide high volumetric and gravimetric efficiency in batteries and battery packs. Such batteries and battery packs can be used in many applications, for example in portable electronic devices and in fuel-saving vehicles.

These batteries and battery packs are generally arranged in the form of electrically interconnected individual battery modules containing a number of individual battery cells. However, the manufacturing process for positioning and attaching the cells within the battery module can be costly, due to issues such as the amount of time it takes to position and attach the cells and the costs associated with materials and equipment used to attach the cells.

Therefore, there is a need to develop designs and methods for improving the manufacturing of batteries, and in particular, the joining of cells to a battery cold plate. The present disclosure satisfies these and other needs.

### BRIEF DESCRIPTION OF THE DRAWINGS

FIG. 1 shows a side view of cells joined to a cold plate in a prior art configuration;

FIG. 2 shows a side view of a UV-curing process in accordance with embodiments of the present disclosure;

FIG. 3 shows an isometric view of a transparent cold plate in accordance with embodiments of the present disclosure;

FIG. 4 shows a side view of a UV-curing process in accordance with embodiments of the present disclosure; and

FIG. 5 shows methods for UV-curing processes in accordance with embodiments of the present disclosure.

### DETAILED DESCRIPTION

Embodiments of the present disclosure will be described in connection with battery modules, and in some embodiments, the construction, structure, and arrangement of components making up battery modules and the methods of manufacturing battery modules.

An electrical energy storage device for a vehicle may include one or more battery packs, each including a number of battery modules electrically interconnected with one another to provide electromotive force for the electrical drive system of a vehicle to operate. Each battery module in the battery pack can include any number of battery cells contained and/or arranged within a battery module housing and adjacent to a cold plate.

In various embodiments, the battery cells are attached to a cold plate (which may also be referred to as a “coldplate” or a “cooling plate”) at a bottom side of each cell. The cold plate can act as a heatsink so that the cells are cooled during operation to help control cell temperature. Cells are conventionally adhered to a cold plate using a thermally-conductive and electrically-insulative adhesive that can be cured, for example, by waiting a certain amount of time or by applying heat. In some methods and systems, a compressible thermally conductive foam pad (sometimes called a “gap pad”) is provided between the cells and the cold plate instead of using an adhesive.

One problem with battery modules is the cost that is incurred to manufacture the battery module. For example, processes that attach battery cells to a cold plate can use gap-pads, liquid gap-filler, and/or thermal adhesives to adhere the cells; however, these processes have added costs. The added costs include waste due to variability in the processes, the price of necessary equipment used in the manufacturing processes and components used in the battery modules, the cost and time of equipment maintenance, and the excessive time required by some of the processing steps and maintenance steps. More specifically, it can be time-consuming to apply adhesive and allow for the adhesive to properly cure, and this can create a bottleneck in the process. Also, in processes using two-part epoxies, extra time is required to mix the epoxies and the cure time may be in excess of thirty minutes. In addition, there are other issues that can increase costs when using liquid adhesives, such as equipment maintenance. In particular, in various processes, mixing nozzles for the liquid adhesives may need to be maintained (e.g., scrapped and replaced or purged with solvent) during breaks in the manufacturing process. Still further, the cost of equipment may be problematic (e.g., long ovens may be required to cure the adhesive), and added costs associated with the processing may be problematic (e.g., increased time that is required to cure the adhesive and larger areas for storage required to store the modules while the adhesive is curing). Regarding gap pads, additional packaging is costly and limits design and manufacturing choices. In addition, adhesives and gap pads require additional manufacturing steps that add to the costs. Thus, improvements are needed. Embodiments described herein advantageously reduce or prevent the aforementioned problems.

In various embodiments, a UV-curable adhesive may be used to bond the battery cells to the cold plate. The terms “UV-curable” and “UV-cured” are used herein and may be used interchangeably. Accordingly, the term “UV-cured” may be used to describe an adhesive that can be cured by the application of UV light; however, the adhesive may be in an uncured state. In addition, the term “UV-curable” may be used to describe an adhesive that can be cured by the application of UV light; however, the adhesive may be in a cured state.

In some embodiments, the UV light to cure the UV-curable adhesive may be applied from above the cells. However, if the UV light is applied from above the cells (e.g., from a top side of the cells when it is the bottom of the cells that are being adhered to the cold plate), then a problem occurs that the UV light cannot reach portions of the adhesive at the bottoms of the battery cells. Thus, in various embodiments, the cold plate may be transparent to allow the UV light to pass through the cold plate, and the UV light may be applied from a bottom side of the cold plate to the adhesive in order to cure the adhesive and bond the battery cells to the cold plate.

As used herein, the terms “top” and “bottom” correspond to “upper” and “lower” and when referring to the cold plate, refer to an orientation where, when the cold plate is assembled with the cells, the top side (e.g., a top surface) of the cold plate is in contact with the cells and the bottom side (e.g., a bottom surface) is opposite the top surface. Also, the height of the cold plate is a distance between the top surface and the bottom surface. The terms “top” and “bottom” can also correspond to the terms “upper” and “lower” as used herein.

The terms “top” and “bottom” are also used herein to refer to the battery cells, with the bottom side of the battery cells being in contact with the adhesive applied to the cold plate. The positive and negative terminals of the cells may or may not correspond to the tops and bottoms of the cells. In some embodiments, the headers of the cells are at the tops of the cells with the bottoms of the cells being in contact with the adhesive (e.g., adjacent to the cold plate). However, the headers of the cells may be at the bottoms of the cells and in contact with the adhesive (e.g., adjacent to the cold plate).

In various embodiments, the cold plate may include a transparent material. The cold plate may be entirely comprised of the transparent material, or the cold plate may be partially comprised of the transparent material. The cold plate may be made of only one type of material, or only one combination of materials. Alternatively, the cold plate may include different materials in any configuration. As used herein, the term “transparent cold plate” may refer to any of these configurations (e.g., a cold plate made entirely of a transparent material, a cold plate made of different materials, etc.).

In various embodiments, the transparent cold plate is thermally conductive to transmit heat to and from the cells. In addition, the transparent cold plate transmits the UV light (e.g., applied from a bottom side of the cold plate) to the UV-curable adhesive (applied on the top side of the cold plate). Thus, in some embodiments, the UV light source is located adjacent to the bottom side of the transparent cold plate. If the assembly (e.g., the battery cells, the adhesive, and the cold plate) is in an upright position, then the UV light may be applied from a UV light source that is beneath the bottom side of the transparent cold plate. If the assembly is in an inverted position (e.g., the assembly is in an upside down position where the tops of the cells are under the bottoms of the cells and the top side of the cold plate is below the bottom side of the cold plate), then the UV light may be applied from a UV light source that is above the bottom side of the transparent cold plate and transmitting the UV light in a downward direction. However, the UV light source may be located in any manner and at any location to transmit UV light to the UV-curable adhesive.

In certain aspects, the UV-curable adhesive may be applied to the bottom of each battery cell individually. The cells may be in an inverted position (e.g., with their bottom sides being above their top sides) and held in place by a carrier when the adhesive is applied. After the adhesive is applied, the cold plate may be placed against the cells (e.g., with the cold plate also being in an inverted position so that the top side of the cold plate is below the bottom side and the top side of the cold plate is placed in contact with the adhesive applied to the bottom sides of the cells).

When the cold plate is applied to the bottom of the battery cells so that the adhesive is between the battery cells and the cold plate, the assembly (e.g., the battery cells and cold plate with adhesive) may be flipped so that the cells are in an upright position (e.g., the tops of the cells are above the bottoms of the cells) and the cold plate is underneath the cells when viewed from a side view. Prior to, during, or after the assembly is flipped, the adhesive may spread along the cold plate to cover portions of the cold plate that are between the battery cells. Alternatively, the adhesive may not spread to entirely cover the portions of the cold plate that are between the battery cells. Thus, in some embodiments there may be spaces (e.g., gaps) on the cold plate that are without adhesive between the cells, or in other embodiments the adhesive layer may continuously cover the cold plate so that there are no gaps in the adhesive between the cells at the surface of the cold plate on which the battery cells are adhered.

In some embodiments, a UV-light source supplies UV-light to the adhesive to cure the adhesive. The UV-light may be applied from above or below the assembly. In certain aspects, the UV-light may be applied from the bottom side of the transparent cold plate so that the UV-light transmits through the cold plate (e.g., from the bottom side of the cold plate to the top side of the cold plate) to the adhesive to UV-cure the adhesive. This may be done prior to flipping the assembly (e.g., so that the UV light source is above the bottom side of the cold plate and transmitting the UV light in a downward direction) or after the assembly is flipped to the upright position (e.g., so that the UV light source is below the bottom side of the cold plate and transmitting the UV light in an upward direction).

In certain aspects, the cure time of the UV-curable adhesives may be much shorter than cure times of conventional adhesives. This advantageously may reduce processing time and eliminate or reduce additional costs (e.g., additional processing steps, additional equipment required, and bottlenecks in the process, among others). For example, steps to store assemblies during the cure time, or heat the assemblies, or move the assemblies to and from (or through) ovens, may not be required. This streamlines the manufacturing processes and reduces costs. Further, the use of UV-curable adhesives may provide improved handling during manufacturing due to being able to position the cells in less time (e.g., due to the faster speed of curing) and being able to rotate the joined cells and cold plate in less time (e.g., due to the faster speed of curing).

In various aspects, UV-curable adhesives may have improved storage properties. In some embodiments, UV-curable adhesives are more shelf stable than conventional adhesives (e.g., they have an increased length of time that they may be stored (versus various conventional adhesives) without becoming unfit for their purpose). Having an improved shelf stability advantageously reduces waste during the manufacturing process.

In some aspects, the UV light required to cure the UV-curable adhesives may be less costly and easier to apply than other curing methods. For example, two-part epoxies require mixing and application nozzles, which add to the costs. The equipment for the mixing and for the application nozzles must be maintained because the two-part epoxy will begin to cure upon being mixed and will adhere to the equipment over time. In addition, thermal adhesives require heat to cure (e.g., ovens may be used to provide the required heat) and there is additional cost associated with maintaining and using this equipment. A UV light source can be less costly to purchase, maintain, and use (e.g., emitting UV light) than conventional curing equipment and can be easily portable, which also reduces costs.

Advantageously, the transparent cold plate may be a same or similar shape as prior art cold plates. This can allow other manufacturing and processing equipment to be the same, and thereby provide cost savings when implementing the transparent cold plate in the assemblies. In various embodiments, the transparent cold plate may be thicker than conventional cold plates; however, in spite of the difference in size, the transparent cold plate may still be used with the same conventional manufacturing and processing equipment.

In some aspects, the transparent cold plate may have a lighter weight than conventional cold plates. The transparent cold plate may have a lighter weight than conventional cold plates even if the transparent cold plate is thicker than conventional cold plates. Advantageously, a lighter weight of the transparent cold plate will reduce the weight of the battery module, which in turn increases the gravimetric energy density of the module by increasing the energy of the module in comparison to the weight of the module. Increases in gravimetric energy density are advantageous in order to improve the performance of the module.

Advantageously, the thermal performance of the transparent cold plate may be similar to a conventional cold plate made of aluminum; however, even if the thermal performance decreases, the decrease may be an acceptable amount when considering the other advantages provided by the present embodiments.

In various embodiments, the transparent cold plate is made out of materials that are not electrically conductive (e.g., plastics). This is in contrast to conventional cold plates, where the materials are electrically conductive (e.g., aluminum) and require additional process steps and components to electrically isolate the conventional cold plate from the cells and from other module components. For example, in conventional modules, an insulation barrier may be required between the cells and the cold plate. However, in the present embodiments, no insulation barrier is required between the cells and the transparent cold plate because the transparent cold plate is advantageously not electrically conductive. Thus, process steps in manufacturing the module are reduced and the number of module components are reduced, thereby saving costs and simplifying the design of the module. In addition, the weight of the module is reduced, which improves the gravimetric energy density of the module.

Embodiments described herein can provide battery modules, including: energy storage cells, each of the energy storage cells having an upper side and a lower side, where the energy storage cells are arranged in a pattern with each energy storage cell being spaced apart from one another, and wherein the upper sides of each of the energy storage cells are adjacent to one another; a cold plate comprising a transparent material; and a UV-curable adhesive in contact with the cold plate and each of the energy storage cells.

Embodiments described herein can provide methods of manufacturing battery modules, including: positioning energy storage cells in a pattern with each energy storage cell being spaced apart from one another, where upper sides of each of the energy storage cells are adjacent to one another; applying a UV-curable adhesive in contact with each of the energy storage cells and a cold plate comprising a transparent material; and applying a UV-light to the UV-curable adhesive.

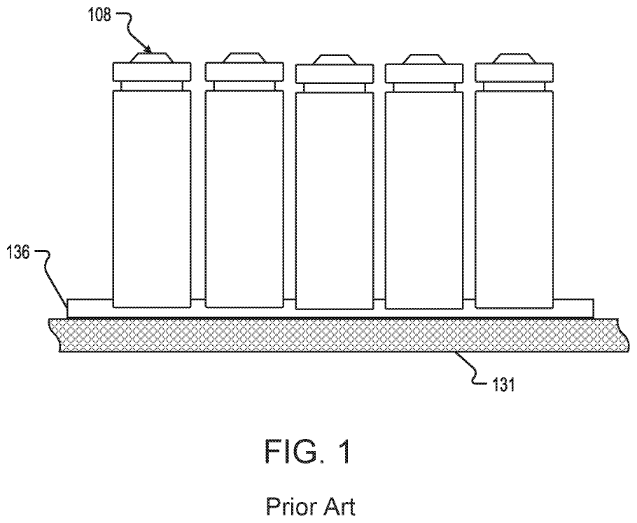

FIG. 1 shows a side view of cells joined to a cold plate in a prior art configuration. In FIG. 1, the cells 108 are arranged with bottom surfaces of the cells being adjacent to a cold plate 131. An adhesive 136 is disposed between the cells 108 and the cold plate 131. The cold plate 131 shown in FIG. 1 is opaque and may be made from aluminum. The adhesive 136 may be a thermal adhesive or a two-part epoxy, for example, or a gap pad may be used instead of an adhesive 136.

As discussed herein, there are many problems associated with the use of a conventional adhesive 136 to bond cells 108 to a cold plate 131, as illustratively shown in FIG. 1. For example, longer amounts of time are required to cure the adhesive (and, in the case of two-part epoxy adhesives, mix the adhesive and maintain the equipment, including scraping the nozzles) and this can create a manufacturing bottleneck. The long time required to cure can be especially problematic and costly for conventional two-part epoxies, which may take about twenty minutes or more to cure. During the cure time, the assemblies must be stored, which adds to costs (e.g., needs for additional storage space, resources to transport the assemblies to and from storage locations, increased possibilities of errors occurring during the extra processing steps, etc.). Further, the consistency and quality of the conventional adhesives can suffer as a result of the extra steps required in the application process (e.g., mixing a two-part epoxy, and the timing requirements for applying the two-part epoxy once mixed). In addition, if ovens are required to heat thermally cured adhesives, the cost of purchasing and maintaining the ovens adds to undesirable process costs, as well as costs associated with placing the assemblies within the ovens, removing the assemblies from the ovens, and the space requirements for using the ovens, among others.

Alternatives to conventional adhesives can also be costly, such as the use of a “gap pad.” A gap pad is a compressible foam pad with thermally conductive particles in it that may be used in place of a conventional adhesive. However, there are additional costs associated with using a gap pad. For example, gap pads have additional packaging, which is often incompatible with various design decisions for modules. In addition, the use of gap pads increases costs due to additional processing steps that are required (e.g., placement and attachment of the gap pads). Another problem with gap pads is that it is possible for the manufacturer to mistakenly leave the gap pad out, which results in waste and added costs. Advantageously, embodiments disclosed herein reduce costs and improve design by addressing at least some of these problems and other problems not explicitly described herein.

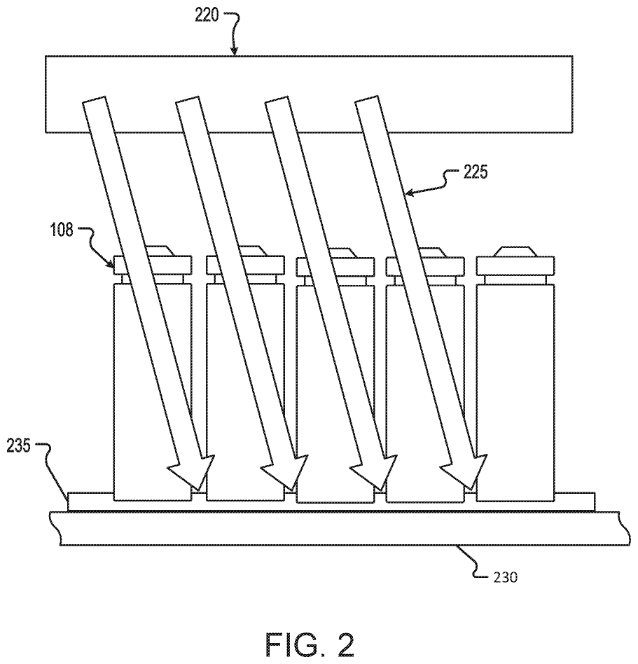

FIG. 2 shows a side view of a UV-curing process in accordance with embodiments of the present disclosure. In FIG. 2, the cells 108 are arranged with bottom surfaces of the cells being adjacent to a cold plate 230. The cells 108 may be held in such an arrangement (or any arrangement) by a carrier (not shown). A UV-curable adhesive 235 is disposed between the cells 108 and the cold plate 230. In the embodiments shown in FIG. 2, the UV-curable adhesive 235 is continuously covering a portion of the cold plate 230 on the side of the cold plate 230 adjacent to the cells and at least between each of the cells 108. Although the UV-curable adhesive 235 is shown as continuously covering an entirety of the first surface of the cold plate 230 between each of the energy storage cells 108, the UV-curable adhesive 235 may not continuously cover the surface of the cold plate 230 between every one of the cells 108 (e.g., it may have gaps in coverage along the cold plate 230 between two or more of the cells 108. In various embodiments, the adhesive 235 can include mechanical separation elements (not shown) positioned between the cold plate 230 and each of the cells 108.

As shown in FIG. 2, a surface of the cold plate 230 is closest to the cells 108 and is in contact with the adhesive 235. A UV light source 220 is projecting UV light onto the cells 108 and adhesive 235 from above the top side of the cells 108 (e.g., the UV light source 220 is above the top sides of the cells 108 and projecting, or transmitting, UV light 225 in a downward direction to the UV-curable adhesive 235. Although the UV light is shown in FIG. 2 as being projected at a slant (e.g., at an angle that is not perpendicular to the UV light source 220), the UV light 225 may be applied to the UV-curable adhesive 235 in any manner.

The cold plate 230 shown in FIG. 2 may be opaque or transparent. If the cold plate 230 is opaque, then UV light will not transmit through the cold plate 230 and if the UV light is applied to the UV-curable adhesive 235 from a location above the cold plate (e.g., from above a top side of the cells 108 when it is the bottom of the cells 108 that are being adhered to the cold plate 235), then a problem occurs that the UV light 225 cannot reach portions of the UV-curable adhesive 235 at the bottoms of the battery cells 108 due the cells 108 blocking portions of the UV light 225, and this problem may be exacerbated due to the close cell packing on the cold plate. Thus, it can be difficult to use a UV-cured adhesive 235 to adhere cells 108 to a cold plate 235 when light is applied from above the cells 108. However, if the cold plate 230 is transparent, the UV light may be applied through the cold plate 230, as explained further herein.

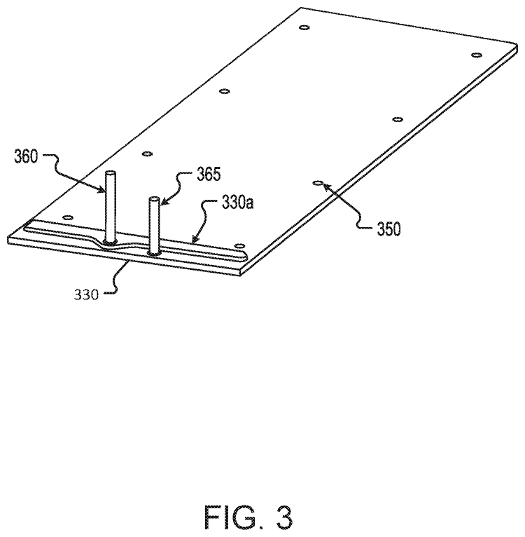

FIG. 3 shows an illustrative transparent cold plate 330 in accordance with embodiments of the present disclosure. The transparent cold plate 330 may have a same or similar shape and dimensions as other cold plates with the only difference being one or more materials of the cold plate 330 (e.g., the cold plate 330 shown in FIG. 3 is transparent for at least a portion of the cold plate 330 or the entirety of the cold plate 330).

The cold plate 330 may have other components connected to, or integral with, the cold plate 330. For example, the cold plate 330 may have attachment points 350 for mount sleeves, coolant ports 360 and 365, and/or other components not shown. Also, a raised portion 330a of the transparent cold plate 330 may have any size or shape and may be absent in various embodiments.

The cooling plate 224 may be configured to convey a coolant or other fluid therethrough (e.g., via cooling ports 360/365), thereby cooling at least one surface of the cooling plate and objects (e.g., battery cells, etc.) that are in contact with the at least one surface. In some embodiment, the battery cells (not shown in FIG. 3) may be mechanically adhered to the cooling plate via a UV-cured adhesive, as discussed herein.

To have an appropriate or desirable strength, the transparent cold plate 330 may have a similar or same width and length as conventional cold plates; however, the transparent cold plate 330 may be thicker (by, for example, about 50%, or about 1 mm to about 1.5 mm) than conventional cold plates. The width, length, and thickness of cold plates, as described herein, may not include the dimensions of the raised portion 330a. The cold plate may have a thickness that is greater than, less than, or the same as, conventional cold plates. In certain embodiments, the cold plate may have a thickness that is typically about 25% greater than that of conventional cold plates, more typically about 30% greater than that of conventional cold plates, more typically about 35% greater than that of conventional cold plates, more typically about 40% greater than that of conventional cold plates, more typically about 45% greater than that of conventional cold plates, and more typically about 50% greater than that of conventional cold plates. The thickness of the cold plate may be more than about 50% greater than that of conventional cold plates, including typically about 55% greater than that of conventional cold plates, more typically about 60% greater than that of conventional cold plates, and more typically about 65% greater than that of conventional cold plates.

The thickness of the cold plate may be typically about 0.7, more typically about 0.8 mm, more typically about 0.9 mm, more typically about 1 mm, more typically about 1.1 mm, more typically about 1.2 mm, more typically about 1.3 mm, more typically about 1.4 mm, more typically about 1.5 mm, more typically about 1.6 mm, more typically about 1.7 mm, and more typically about 1.8 mm.

For example, some conventional aluminum cold plates are between 0.7 mm to 1.0 mm thick, and transparent cold plates that may be used in embodiments disclosed herein may be between about 1 mm to about 1.5 mm thick. Advantageously, the transparent cold plate 330 may be lighter than conventional cold plates.

The transparent cold plate 330 may be made from molded, formed, or otherwise shaped plastic, dielectric, or nonconductive material. The materials used for the transparent cold plate 330 may include plastics, such as derivatives of polycarbonate. The materials of the transparent cold plate 330 may be mixed or combined with other materials. For example, the materials may have a ceramic (e.g., aluminum nitride, aluminum oxide, etc.) added (e.g., within the matrix of the materials) to improve desirable properties, such as an increased thermal conductivity. The added ceramic may be electrically insulative. The materials of the cold plate may be any material and is not limited by the description herein.

An illustrative example of a material that may be used for the transparent cold plate 330 is Bayblend® FR3010, which is a polycarbonate and acrylonitrile butadiene styrene blend that is flame retardant, has desirable heat resistance, and desirable chemical resistance and stress cracking behavior. In particular, it may have the following properties shown below in Table 1:

TABLE 1

| | | | | |
|---|---|---|---|---|
| Property | Test Condition | Unit | Standard | Typical Value |

Mechanical properties (23° C./50% r.h.)

| | | | | | |
|---|---|---|---|---|---|
| Tensile modulus | 1 | mm/min | MPa | ISO 527-1, -2 | 2700 |
| Yield stress | 50 | mm/min | MPa | ISO 527-1, -2 | 60 |
| Yield strain | 50 | mm/min | % | ISO 527-1, -2 | 4 |
| Stress at break | 50 | mm/min | MPa | ISO 527-1, -2 | 50 |
| Strain at break | 50 | mm/min | % | b.o. ISO 527-1, -2 | >50 |
| Izod impact strength | 23° | C. | kJ/m² | ISO 180-U | N |
| Izod notched impact strength | 23° | C. | kJ/m² | ISO 180-A | 35 |
| Izod notched impact strength | −30° | C. | kJ/m² | ISO 180-A | 10 |

Thermal properties

| Temperature of deflection under load | 1.80 | MPa | ° C. | ISO 75-1, -2 | 90 |
|---|---|---|---|---|---|
| Temperature of deflection under load | 0.45 | MPa | ° C. | ISO 75-1, -2 | 100 |
| Vicat softening temperature | 50N; 50° C./h | | ° C. | ISO 306 | 108 |
| Vicat softening temperature | 50N; 120° C./h | | ° C. | ISO 306 | 110 |
| Coefficient of linear thermal | 23 to 55° | C. | 10⁻⁴/K | ISO 11359-1, -2 | 0.76 |
| expansion, parallel | | | | | |
| Coefficient of linear thermal | 23 to 55° | C. | 10⁻⁴/K | ISO 11359-1, -2 | 0.8 |
| expansion, transverse | | | | | |
| Burning behavior UL 94 (1.5 mm) | 1.5 | mm | Class | UL 94 | V-0 |
| [UL recognition] | | | | | |
| Burning behavior UL 94-5V | 2.0 | mm | Class | UL 94 | 5VB |
| [UL recognition] | | | | | |
| Burning behavior UL 94-5V | 3.0 | mm | Class | UL 94 | 5VA |
| [UL recognition] | | | | | |

| | | | | |
|---|---|---|---|---|
| Oxygen index | Method A | % | ISO 4589-2 | 32 |

Electrical properties (23° C./50% r.h.)

| | | | | | |
|---|---|---|---|---|---|
| Relative permittivity | 100 | Hz | — | IEC 60250 | 3.2 |
| Relative permittivity | 1 | MHz | — | IEC 60250 | 3.1 |
| Dissipation factor | 100 | Hz | 10⁻⁴ | IEC 60250 | 50 |
| Dissipation factor | 1 | MHz | 10⁻⁴ | IEC 60250 | 70 |
| Volume resistivity | | | Ohm · m | IEC 60093 | 1E+14 |
| Surface resistivity | | | Ohm | IEC 60093 | 1E+16 |
| Electrical strength | 1 | mm | kV/mm | IEC 60243-1 | 35 |

| | | | | |
|---|---|---|---|---|
| Comparative tracking index CTI | Solution A | Rating | IEC 60112 | 350 |

An illustrative example of a material that may be used for the transparent cold plate 330 is Bayblend® FR3040 a polycarbonate and acrylonitrile butadiene styrene blend that is flame retardant and has desirable burning behavior in small wall thicknesses. In particular, it may have the following properties shown below in Table 2:

TABLE 2

| | | | | |
|---|---|---|---|---|
| Property | Test Condition | Unit | Standard | Typical Value |

Mechanical properties (23° C./50% r.h.)

| | | | | | |
|---|---|---|---|---|---|
| Tensile modulus | 1 | mm/min | MPa | ISO 527-1, -2 | 2700 |
| Yield stress | 50 | mm/min | MPa | ISO 527-1, -2 | 65 |
| Yield strain | 50 | mm/min | % | ISO 527-1, -2 | 4 |
| Stress at break | 50 | mm/min | MPa | ISO 527-1, -2 | 50 |
| Strain at break | 50 | mm/min | % | b.o. ISO 527-1, -2 | >50 |
| Izod impact strength | 23° | C. | kJ/m² | ISO 180-U | N |
| Izod notched impact strength | 23° | C. | kJ/m² | ISO 180-A | 30 |

Thermal properties

| Temperature of deflection under load | 1.80 | MPa | ° C. | ISO 75-1, -2 | 91 |
|---|---|---|---|---|---|
| Temperature of deflection under load | 0.45 | MPa | ° C. | ISO 75-1, -2 | 100 |
| Vicat softening temperature | 50N; 50° C./h | | ° C. | ISO 306 | 106 |
| Vicat softening temperature | 50N; 120° C./h | | ° C. | ISO 306 | 108 |
| Coefficient of linear thermal | 23 to 55° | C. | 10−4/K | ISO 11359-1, -2 | 0.76 |
| expansion, parallel | | | | | |
| Coefficient of linear thermal | 23 to 55° | C. | 10−4/K | ISO 11359-1, -2 | 0.8 |
| expansion, transverse | | | | | |
| Burning behavior UL 94 | 0.75 | mm | Class | UL 94 | V-0 |
| [UL recognition] | | | | | |
| Burning behavior UL 94-5V | 1.5 | mm | Class | UL 94 | 5VB |
| [UL recognition] | | | | | |
| Burning behavior UL 94-5V | 3.0 | mm | Class | UL 94 | 5VA |
| [UL recognition] | | | | | |

| | | | | |
|---|---|---|---|---|
| Oxygen index | Method A | % | ISO 4589-2 | 35 |

Electrical properties (23° C./50% r.h.)

| | | | | | |
|---|---|---|---|---|---|
| Relative permittivity | 100 | Hz | — | IEC 60250 | 3.2 |
| Relative permittivity | 1 | MHz | — | IEC 60250 | 3.1 |
| Dissipation factor | 100 | Hz | 10−4 | IEC 60250 | 50 |
| Dissipation factor | 1 | MHz | 10−4 | IEC 60250 | 75 |
| Volume resistivity | | | Ohm · m | IEC 60093 | 1E+15 |
| Surface resistivity | | | Ohm | IEC 60093 | 1E+17 |
| Electrical strength | 1 | mm | kV/mm | IEC 60243-1 | 35 |

| | | | | |
|---|---|---|---|---|
| Comparative tracking index CTI | Solution A | Rating | IEC 60112 | 325 |

An illustrative example of a material that may be used for the transparent cold plate 330 is Makrolon® 1899, which is flame retardant and has desirable impact, viscosity, and release properties. In particular, it may have of the following properties shown below in Table 3:

TABLE 3

| | | | | |
|---|---|---|---|---|
| Property | Test Condition | Unit | Standard | Typical Value |

Mechanical properties (23° C./50% r.h.)

| | | | | | |
|---|---|---|---|---|---|
| Tensile modulus | 1 | mm/min | MPa | ISO 527-1, -2 | 2600 |
| Yield stress | 50 | mm/min | MPa | ISO 527-1, -2 | 68 |
| Yield strain | 50 | mm/min | % | ISO 527-1, -2 | 4.8 |
| Nominal strain at break | 50 | mm/min | % | ISO 527-1, -2 | >50 |
| Stress at break | 50 | mm/min | MPa | ISO 527-1, -2 | 60 |
| Strain at break | 50 | mm/min | % | b.o. ISO 527-1, -2 | 115 |
| Flexural modulus | 2 | mm/min | MPa | ISO 178 | 2600 |
| Flexural strength | 2 | mm/min | MPa | ISO 178 | 100 |
| Flexural strain at flexural strength | 2 | mm/min | % | ISO 178 | 5.8 |
| Flexural stress at 3.5% strain | 2 | mm/min | MPa | ISO 178 | 82 |
| Charpy impact strength | 23° | C. | kJ/m² | ISO 179-1eU | N |
| Charpy impact strength | −30° | C. | kJ/m² | ISO 179-1eU | N |
| Puncture maximum force | 23° | C. | N | ISO 6603-2 | 4500 |
| Puncture maximum force | −30° | C. | N | ISO 6603-2 | 5400 |
| Puncture energy | 23° | C. | J | ISO 6603-2 | 50 |
| Puncture energy | −30° | C. | J | ISO 6603-2 | 55 |

Thermal properties

| Temperature of deflection under load | 1.80 | MPa | ° C. | ISO 75-1,-2 | 96 |
|---|---|---|---|---|---|
| Temperature of deflection under load | 0.45 | MPa | ° C. | ISO 75-1,-2 | 105 |
| Vicat softening temperature | 50N; 50° C./h | | ° C. | ISO 306 | 110 |
| Coefficient of linear thermal | 23 to 55° | C. | 10−4/K | ISO 11359-1, -2 | 0.7 |
| expansion, parallel | | | | | |
| Coefficient of linear thermal | 23 to 55° | C. | 10−4/K | ISO 11359-1, -2 | 0.7 |
| expansion, transverse | | | | | |
| Burning behavior UL 94 | 0.75 | mm | Class | UL 94 | V-0 |
| [UL recognition] | | | | | |
| Burning behavior UL 94-5V | 3.0 | mm | Class | UL 94 | 5VA |

| | | | | |
|---|---|---|---|---|
| Oxygen index | Method A | % | ISO 4589-2 | 35 |

Electrical properties (23° C./50% r.h.)

| | | | | |
|---|---|---|---|---|
| Comparative tracking index CTI | Solution A | Rating | IEC 60112 | 250 |
| Comparative tracking index CTI M | Solution B | Rating | IEC 60112 | 100M |

If the transparent cold plate 330 has similar or the same characteristics to cold plates used in conventional devices, there may be associated advantages, including the ability to use preexisting manufacturing processes and/or equipment to manufacture the battery module with the transparent cold plate.

Advantageously, the transparent cold plate 330 may be a lighter weight than conventional cold plates, even if the thickness of the transparent cold plate is increased to maintain its strength when using the transparent materials. Further, the thermal performance of the transparent cold plate 330 may advantageously be similar to conventional cold plates. However, even if the thermal performance of the transparent cold plate decreases relative to a conventional cold plate, such a decrease may be acceptable when considering the other advantages provided by the transparent cold plate.

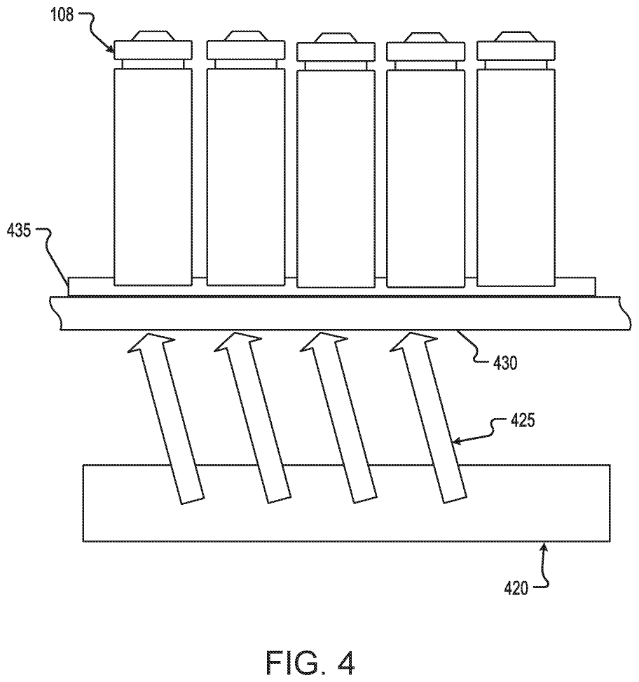

FIG. 4 shows a side view of a UV-curing process in accordance with embodiments of the present disclosure. In FIG. 4, a transparent cold plate 430 is used. The cells 108 are in contact with a UV-cured adhesive 435, which is between the cells 108 and the transparent cold plate 430. The UV-cured adhesive 435 is cured with a UV light source 420 that emits UV light 425 and, once cured, the UV-cured adhesive 435 structurally connects the cells 108 to the transparent cold plate 430.

As shown in FIG. 4, the UV light source 420 is positioned below the transparent cold plate 430 (e.g., below the bottom side of the transparent cold plate, which is on the opposite side of the transparent cold plate 430 from the cells 108 and the UV-curable adhesive 435). The UV light source 420 is projecting UV light 425 onto the cells 108 and UV-curable adhesive 435 from below the bottom sides of the cells 108 (e.g., the UV light source 420 is below the bottom sides of the cells 108 as well as below the bottom side of the transparent cold plate 430 and the UV light source 420 is projecting, or transmitting, UV light 425 in an upward direction to the UV-curable adhesive 435. Thus, advantageously, the transparent cold plate 430 transmits the UV light 425 through itself to the UV-curable adhesive 435 to cure the UV-curable adhesive 435. Advantageously, by transmitting the UV light 425 through the transparent cold plate 430 to the UV-curable adhesive 435, the UV light 425 is not partially blocked by the cells 108 (e.g., as it was when the UV light was transmitted from above the cells as shown in FIG. 2). Although the UV light 425 is shown in FIG. 4 as being projected at a slant (e.g., at an angle that is not perpendicular to the UV light source 420), the UV light 425 may be applied to the UV-curable adhesive 435 in any manner.

The transparent cold plate 430 is thermally conductive and the UV-curable adhesive 435 is also thermally conductive. In some embodiments, the UV-curable adhesive 435 material may include mechanical separation elements embedded therein (e.g., beads, etc.), configured to separate the bottom surface of the cells 108 from the transparent cooling plate 430 surface a known distance. Among other things, this separation may provide a predictable thermal conductive path between the cooling plate 430 and the cells 108 via the thermally conductive the UV-curable adhesive 435 material.

Any method and means may be used to arrange and connect the cells 108 to the transparent cold plate 430. For example, UV-curable adhesive may be applied to the bottom of each of the cells 108 individually when the cells 108 are in an inverted position, and after the transparent cold plate 430 is placed on the UV-curable adhesive, there may be spaces (e.g., gaps) that are devoid of any of the UV-curable adhesive 435 on the transparent cold plate 430 between the cells 108. Alternatively, after the transparent cold plate 430 is placed on the UV-curable adhesive, the UV-curable adhesive 435 may spread along the transparent cold plate 430 to continuously cover the transparent cold plate 430 without any gaps in coverage (e.g., the UV-curable adhesive 435 may be a single and continuous layer along at least a portion of the one side of the transparent cold plate 430 that is adjacent to the cells 108).

In various embodiments, the UV-curable adhesive may be a general purpose adhesive with any of the following properties: medium viscosity, rigidness, tacky free, non-yellowing, and high bonding strength for plastic. The UV-curable adhesive may be clear and have a viscosity of about 3,000 cPs to about 11,000 cPs before it is cured (e.g., when in a liquid state), a cure energy of about 2,400 mJ/cm³, a hardness of about 56 Shore D to about 70 Shore D when it is cured, and a shelf life of about 12 months at 8-25° C.

The cure time of the UV-curable adhesive may be any cure time. In various embodiments, the cure time of the UV-curable adhesive may be significantly less than 20 minutes. For example, the cure time may be typically between about 2 seconds and about 2 minutes, more typically between about 2 seconds and about 1 minute, more typically between about 2 seconds and about 30 seconds, more typically between about 2 seconds and about 10 seconds, more typically between about 2 seconds and about 7 seconds. Further, the cure time may be typically about 3 seconds, more typically about 4 seconds, and more typically about 5 seconds.

The wavelength of UV light that is used to cure the UV-curable adhesive may be any wavelength that cures the UV-curable adhesive. The wavelength of UV light that is used to cure the UV-curable adhesive may be typically between about 335 nm and about 395 nm, more typically between about 340 nm and about 390 nm, more typically between about 345 nm and about 385 nm, more typically between about 350 nm and about 380 nm, more typically between about 355 nm and about 375 nm, more typically between about 360 nm and about 370 nm, and more typically about 365 nm.

The bond strength of the UV-cured adhesive may be a lap shear strength (at 25° C.) of typically between about 2000 PSI and about 2600 PSI, more typically between about 2050 PSI and about 2550 PSI, more typically between about 2100 PSI and about 2500 PSI, more typically between about 2150 PSI and about 2450 PSI, more typically between about 2200 PSI and about 2400 PSI, more typically between about 2250 PSI and about 2350 PSI, and more typically about 2300 PSI.

Advantageously, using a UV-curable adhesive to bond the cells to a transparent cold plate and applying the UV light from a bottom side of the transparent cold plate (e.g., so that the UV light is directed through the transparent cold plate) reduces and eliminates many problems with conventional methods and systems. Illustrative advantages include, for example, that the UV adhesives are shelf stable (thereby reducing waste), they have faster cure times than conventional adhesives (thereby improving efficiency, improving quality, reducing costs, reducing required materials, reducing process steps, and improving handling during manufacturing due to being able to position the cells in less time and being able to rotate the joined cells and transparent cold plate in less time), they can take the place of gap pads (thereby improving efficiency, improving quality, reducing costs, reducing required materials, reducing process steps, and improving handling during manufacturing due to being able to position the cells in less time and being able to rotate the joined cells and transparent cold plate in less time).

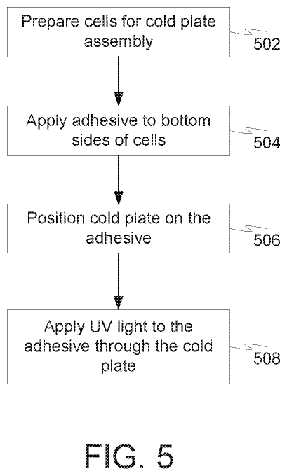

FIG. 5 shows methods for UV-curing processes in accordance with embodiments of the present disclosure. The illustrative methods start at step 502, where the cells are prepared for transparent cold plate assembly. In step 502, the cells are arranged in a carrier, where they may be placed into the carrier so that they are separated from each other with the cell bottoms exposed. In various embodiments, the carrier may arrange the cells such that a limited surface area on the bottoms of the cells is exposed. The cells, when arranged in the carrier, may be rotated with the carrier to be in an inverted position, so that the bottoms of the cells are above the tops of the cells (e.g., the cells and carrier are upside-down).

In step 504, a UV-curable adhesive is applied to the bottom sides of the cells. For example, if the cells are inverted with the exposed cell bottoms facing upwards, the UV-curable adhesive is applied to the cells bottoms with the cells in the inverted position so that the UV-curable adhesive is on top of the cell bottoms. Amounts of UV-curable adhesive that are applied to each cell may be selected based on a desired coverage of the UV-curable adhesive that will structurally connect each cell bottom to the transparent cold plate. In some embodiments, the arrangement of the cells within the carrier (e.g., with only the cell bottoms exposed) advantageously prevents UV-curable adhesive from migrating up the sides of the cells. Thus, the UV-curable adhesive is only in contact with the bottoms of the cells.

After applying the UV-curable adhesive, in step 506, the transparent cold plate is positioned onto the UV-curable adhesive (with the transparent cold plate being inverted and the cells remaining inverted so that the entire assembly of the cells, UV-curable adhesive, and transparent cold plate are upside-down). Advantageously, as discussed herein, no insulation barrier is required when using the transparent cold plate because the transparent cold plate is made of electrically insulative material. Thus, the transparent cold plate may be in direct contact with the UV-curable adhesive with the UV-curable adhesive being in direct contact with the cells, and the transparent cold plate may be in direct contact with the cells or other electrically conductive components of the module.

In step 508, UV light is applied to the UV-curable adhesive through the transparent cold plate. In various embodiments, the UV light may be applied for only a few seconds (e.g., three to five seconds) to cure the UV-curable adhesive and bond the cells to the transparent cold plate. This may be done while the assembly is in the inverted (e.g., upside down) position, and after the UV light is applied and the UV-curable adhesive is cured by the UV light, the assembly may be rotated to be in an upright position or whatever position is required for the next step in the module assembly process. Alternatively, the assembly may be rotated to be in an upright position prior to having the UV light applied to the UV-curable adhesive. Thus, after the transparent cold plate is in position against the UV-curable adhesive and the cell bottoms, the assembly is rotated to be right side up (e.g., the transparent cold plate is below the cells) to that the cells and transparent cold plate are in upright positions and then the UV light is applied.

Alternatively, the UV light may be applied through the transparent cold plate to reach the UV-curable adhesive. This may be done when the assembly (e.g., the cells, UV-curable adhesive, and transparent cold plate) is in any position (e.g., upside down or right side up) and before or after the assembly is rotated. Thus, no matter what position the assembly is in, the UV light may be applied to the UV-curable adhesive through the transparent cold plate (e.g., from an area outside the bottom side of the transparent cold plate so that the UV light is directed through the transparent cold plate to the UV-curable adhesive at the bottoms of the cells).

Once the UV-curable adhesive cures, and hardens into a solid or semi-solid state, the battery cells, and the transparent cold plate are joined together by the UV-curable adhesive. In some embodiments, other components may be used in the processes and systems described herein. For example, additional structural components may interact with the UV-curable adhesive and/or the battery cells and/or the transparent cold plate. By way of example, additional structural components (such as the cell carrier) may be joined together by the UV-curable adhesive. Thus, the UV-curable adhesive may be in contact with other components (e.g., the carrier) and when cured, structurally connect the other components to the assembly.

Assembling the cell can advantageously require minimal changes to conventional manufacturing processes for modules (including processes for assembling the cells together with the cold plate). Main modifications/additions may include the use of a UV light source.

The exemplary systems and methods of this disclosure have been described in relation to a battery module and a number of battery cells in an electric vehicle energy storage system. However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should, however, be appreciated that the present disclosure may be practiced in a variety of ways beyond the specific detail set forth herein.

A number of variations and modifications of the disclosure can be used. It would be possible to provide for some features of the disclosure without providing others. While the present disclosure describes configurations of cells and modules, embodiments of the present disclosure should not be so limited.

Although the present disclosure describes components and functions implemented in the embodiments with reference to particular standards and protocols, the disclosure is not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various embodiments, configurations, and aspects, includes components, methods, processes, systems and/or apparatus substantially as depicted and described herein, including various embodiments, subcombinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and/or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

Embodiments include a battery module comprising energy storage cells, a cold plate, a UV-curable adhesive in contact with the cold plate and each of the energy storage cells. Each of the energy storage cells has an upper side and a lower side and are arranged in a pattern with each energy storage cell being spaced apart from one another and the upper sides of each of the energy storage cells are adjacent to one another. The cold plate comprises a transparent material.

Embodiments include a method of manufacturing a battery module, comprising: positioning energy storage cells in a pattern with each energy storage cell being spaced apart from one another, upper sides of each of the energy storage cells being adjacent to one another; applying a UV-curable adhesive in contact with each of the energy storage cells and a cold plate comprising a transparent material; and applying a UV-light to the UV-curable adhesive.

Aspects include an energy storage device comprising: energy storage cells, each of the energy storage cells having an upper side and a lower side and the energy storage cells being arranged in a pattern with each energy storage cell being spaced apart from one another and the upper sides of each of the energy storage cells being adjacent to one another; a cold plate comprising a transparent material; and a UV-curable adhesive in contact with the cold plate and each of the energy storage cells.

The transparent material can comprise a derivative of polycarbonate.

The transparent material can further comprise a ceramic.

The transparent material can further comprise aluminum nitride.

The cold plate can be the transparent material.

The cure time of the UV-curable adhesive can be between about three seconds to about five seconds.

A wavelength of UV light that cures the UV-curable adhesive can be between about 355 nm to about 375 nm.

The UV-curable adhesive can comprise mechanical separation elements positioned between the cold plate and each of the energy storage cells.

A first surface of the cold plate can be closest to the energy storage cells, and the UV-curable adhesive can continuously cover an entirety of the first surface of the cold plate this is between each of the energy storage cells.

The cold plate can have at least two sides with an upper side being closest to the energy storage cells and a lower side being furthest from the energy storage cells. The UV-curable adhesive can be applied to the UV-curable adhesive in a direction from the lower side to the upper side.

The energy storage cells and cold plate can be in an inverted position when the UV-curable adhesive is applied.

The energy storage cells and cold plate can be in an inverted position when the UV-cured adhesive is applied, and the UV-light can be applied when the energy storage cells and cold plate are in the inverted position. Any one or more of the aspects/embodiments as substantially disclosed herein.

Any one or more of the aspects/embodiments as substantially disclosed herein optionally in combination with any one or more other aspects/embodiments as substantially disclosed herein.

One or more means adapted to perform any one or more of the above aspects/embodiments as substantially disclosed herein.

Examples provided herein are intended to be illustrative and non-limiting. Thus, any example or set of examples provided to illustrate one or more aspects of the present disclosure should not be considered to comprise the entire set of possible embodiments of the aspect in question. Examples may be identified by the use of such language as “for example,” “such as,” “by way of example,” “e.g.,” and other language commonly understood to indicate that what follows is an example.

The present disclosure is not limited in its application to the details of construction and the arrangement of components set forth in the description herein or illustrated in the drawings. The disclosure is capable of other embodiments and of being practiced or of being carried out in various ways. Also, it is to be understood that the phraseology and terminology used herein is for the purpose of description and should not be regarded as limiting. The present disclosure may use examples to illustrate one or more aspects thereof. Unless explicitly stated otherwise, the use or listing of one or more examples (which may be denoted by “for example,” “by way of example,” “e.g.,” “such as,” or similar language) is not intended to and does not limit the scope of the present disclosure.

The term “adhesive” refers to any substance applied to one surface, or both surfaces, of two separate items that binds them together and resists their separation. The adhesive may be non-reactive (e.g., drying, pressure sensitive, contact, or hot) or reactive (e.g., multi-part, pre-mixed, frozen, or one-part) and may be natural or synthetic. It can rely on one or more mechanisms of adhesion, such as a mechanical mechanism and/or chemical mechanism. The surface(s) to be bonded may be activated prior to adhesive application by any surface activation technique, such as plasma activation, flame treatment, and wet chemistry priming.

The term “UV-curable” refers to a process in which ultraviolet light and visible light is used to initiate a photochemical reaction that generates a crosslinked network of polymers. UV curing may be a low temperature process, a low cost process, and a high speed process. Various types of UV lamps may be used in UV curing processes, including but not limited to mercury vapor lamps, fluorescent lamps, and LEDs.

The term “transparent” refers to the physical property of allowing the transmission of various wavelengths of light through a material. Thus, if a material is transparent, it allows the transmission of at least some wavelengths of light through the material.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

What is claimed is:

1. A battery module, comprising:
energy storage cells, each of the energy storage cells having an upper side and a lower side, wherein the energy storage cells are arranged in a pattern with each energy storage cell being spaced apart from one another, and wherein the upper sides of each of the energy storage cells are adjacent to one another;
a cold plate comprising a transparent material; and
a UV-curable adhesive in contact with the cold plate and each of the energy storage cells.

2. The battery module of claim 1, wherein the transparent material comprises a derivative of polycarbonate.

3. The battery module of claim 2, wherein the transparent material further comprises a ceramic.

4. The battery module of claim 2, wherein the transparent material further comprises aluminum nitride.

5. The battery module of claim 1, wherein the cold plate is the transparent material.

6. The battery module of claim 1, wherein a cure time of the UV-curable adhesive is between about three seconds to about five seconds.

7. The battery module of claim 1, wherein a wavelength of UV light that cures the UV-curable adhesive is between about 355 nm to about 375 nm.

8. The battery module of claim 1, wherein the UV-curable adhesive comprises mechanical separation elements positioned between the cold plate and each of the energy storage cells.

9. The battery module of claim 1, wherein a first surface of the cold plate is closest to the energy storage cells, and wherein the UV-curable adhesive continuously covers an entirety of the first surface of the cold plate this is between each of the energy storage cells.

10. A method of manufacturing a battery module, comprising:
positioning energy storage cells in a pattern with each energy storage cell being spaced apart from one another, wherein upper sides of each of the energy storage cells are adjacent to one another;
applying a UV-curable adhesive in contact with each of the energy storage cells and a cold plate comprising a transparent material; and
applying a UV-light to the UV-curable adhesive.

11. The method of claim 10, wherein the cold plate has at least two sides with an upper side being closest to the energy storage cells and a lower side being furthest from the energy storage cells, and wherein the UV-curable adhesive is applied to the UV-curable adhesive in a direction from the lower side to the upper side.

12. The method of claim 11, wherein the energy storage cells and cold plate are in an inverted position when the UV-curable adhesive is applied.

13. The method of claim 11, wherein the energy storage cells and cold plate are in an inverted position when the UV-cured adhesive is applied, and wherein the UV-light is applied when the energy storage cells and cold plate are in the inverted position.

14. The method of claim 10, wherein the UV light has a wavelength between about 355 nm to about 375 nm.

15. The method of claim 10, wherein the UV light is applied for a total time of between about three seconds to about five seconds.

16. The method of claim 10, wherein the transparent material comprises a derivative of polycarbonate.

17. The method of claim 16, wherein the transparent material further comprises a ceramic.

18. The method of claim 16, wherein the transparent material further comprises aluminum nitride.

19. The method of claim 10, wherein the UV-curable adhesive comprises mechanical separation elements positioned between the cold plate and each of the energy storage cells.

20. An energy storage device, comprising:
energy storage cells, each of the energy storage cells having an upper side and a lower side, wherein the energy storage cells are arranged in a pattern with each energy storage cell being spaced apart from one another, and wherein the upper sides of each of the energy storage cells are adjacent to one another;
a cold plate comprising a transparent material; and
a UV-curable adhesive in contact with the cold plate and each of the energy storage cells.
